(19) United States
(12) Patent Application Publication
(10) Pub. No.: US 2023/0321596 A1
(43) Pub. Date: Oct. 12, 2023

(54) METHOD FOR WET REMOVAL OF SULFUR DIOXIDE BY SILICATE BACTERIA-ENHANCED PULP

(71) Applicant: Kunming University of Science and Technology, Kunming City (CN)

(72) Inventors: Yingjie LI, Kunming City (CN); Huaying LIU, Kunming City (CN); Senlin TIAN, Kunming City (CN); Jingyan CHEN, Kunming City (CN); Zimeng NIE, Kunming City (CN); Ziyue LI, Kunming City (CN); Qun ZHAO, Kunming City (CN); Ping NING, Kunming City (CN); Xuewei HU, Kunming City (CN); Jianhong HUANG, Kunming City (CN)

(21) Appl. No.: 18/052,366

(22) Filed: Nov. 3, 2022

(30) Foreign Application Priority Data
Apr. 12, 2022 (CN) 202210377224.9

(51) Int. Cl. B01D 53/50; B01D 53/84; C22B 3/18

(52) U.S. Cl. CPC B01D 53/507; B01D 53/84; B01D 2257/302; B01D 2258/0283; C22B 3/18

(57) ABSTRACT

The present disclosure provides a method for wet removal of sulfur dioxide by silicate bacteria-enhanced pulp. The method includes: treatment of ore waste residue, activation and domestication of silicate bacteria, preparation of pulp, removal of sulfur dioxide, and resource utilization of a desulfurization product. The present disclosure combines flue gas desulfurization with resource utilization of the ore waste residue, and improves a desulfurization efficiency of the method by the pulp and a utilization rate of ore waste residue resources through silicate bacteria. The present disclosure has a high desulfurization efficiency, simple production process, and low cost, and realizes the recycling of resources such as the ore waste residue, the sulfur dioxide, and silicon. The present disclosure has obvious economic and environmental benefits and broad prospects for use.

### CROSS-REFERENCE TO RELATED APPLICATION

This patent application claims the benefit of and priority to Chinese Patent Application No. 202210377224.9, filed on Apr. 12, 2022, the disclosure of which is incorporated by reference herein in its entirety as part of the present application.

### TECHNICAL FIELD

The present disclosure belongs to the technical field of sulfur-containing flue gas treatment and resource utilization of ore waste residue, and in particular relates to a method for wet removal of sulfur dioxide by silicate bacteria-enhanced pulp.

### BACKGROUND

As the most important and most widely used method for purifying sulfur dioxide in flue gas, wet method technology accounts for about 80% of the total treatment capacity, including limestone (lime)-gypsum method, double-alkali method, magnesium oxide method, ammonia method, seawater washing method, and pulp method. The limestone-gypsum method has a large occupied area and a high yield of by-product gypsum. However, the gypsum has limited market, low quality, and is easy to block the pipelines. Therefore, it is of great significance to seek efficient and economically-effective treatment methods of flue gas containing sulfur dioxide to control air pollution. Pulp method is to mix a certain particle size of raw ore/slag with water and other liquids in a certain proportion, and contact with a certain concentration of sulfur dioxide in flue gas. The metal in pulp is leached under acidic conditions, and the sulfur dioxide is absorbed by the pulp. This process effectively removes sulfur dioxide in the flue gas and recovers valuable metals in the ore waste residue by acid leaching, and the separated solid mixture can realize effective recycling after treatment, achieving “waste control by waste”. However, due to factors such as a low grade of ore and the heterogeneity of pulp, it is difficult for the pulp method to achieve a better desulfurization effect. Therefore, it is an inevitable trend to seek a novel method for wet removal of sulfur dioxide by pulp. Therefore, it is highly necessary to develop a method for wet removal of sulfur dioxide by silicate bacteria-enhanced pulp.

### SUMMARY

An objective of the present disclosure is to provide a method for wet removal of sulfur dioxide by silicate bacteria-enhanced pulp.

The wet method includes the following steps:
S1, treatment of ore waste residue: crushing, grinding and sieving the ore waste residue to obtain an ore powder;
S2, activation and domestication of silicate bacteria: conducting activation on the silicate bacteria in an activation medium, and conducting domestication on activated silicate bacteria in a domestication medium;
S3, preparation of pulp: mixing the ore powder obtained in step S1, activated and domesticated silicate bacteria obtained in step S2, nutrients and distilled water to obtain the pulp, conducting culture until the pulp precipitates dissolved silicon, and subjecting the pulp to solid-liquid separation to remove silicon in ore;
S4, removal of sulfur dioxide: subjecting treated pulp obtained in step S3 and flue gas containing sulfur dioxide to a contact reaction, to remove the sulfur dioxide in the flue gas; and
S5, resource utilization of a desulfurization product: subjecting a reaction product obtained in step S4 to solid-liquid separation, impurity removal, concentration and crystallization, and drying sequentially.

Compared with the prior art, the present disclosure has the following technical effects.
1. In the method for wet removal of sulfur dioxide by silicate bacteria-enhanced pulp, the silicate bacteria are activated and domesticated, and the ore powder, the nutrients and the cultivated silicate bacteria are prepared into pulp; the silicate bacteria can effectively decompose silicate minerals in the ore waste residue to release elements such as phosphorus, potassium, manganese, and iron, thereby strengthening an effect of pulp removal on the sulfur dioxide in flue gas. The present disclosure combines flue gas desulfurization with resource utilization of the ore waste residue, and improves a wet desulfurization efficiency of the pulp and a utilization rate of ore waste residue resources through silicate bacteria. The present disclosure has high desulfurization efficiency, simple production process, and low cost, and realizes the recycling of resources such as the ore waste residue, the sulfur dioxide, and silicon. The present disclosure has obvious economic and environmental benefits and broad prospects for use.
2. In the present disclosure, the desulfurization reaction is enhanced by silicate bacteria. The silicate bacteria and ore form bacteria-ore complexes under the action of adhesion, electrostatics, covalent bonds, and van der Waals forces. The growth of bacteria produces mechanical etching on the ore surface, and changes a crystal structure of silicate, leading to the dissolution of insoluble ions; meanwhile, acids produced by the metabolism of silicate bacteria can promote the leaching of transition metal ions, such as Fe and Mn, in the ore waste residue, and have desirable catalytic oxidation ability that is conducive to enhancing a desulfurization performance of the pulp. The silicate bacteria dissolve phosphorus, potassium, iron, and manganese, and effectively leach silicon, thereby realizing silicon activation of silicon-containing ore waste residue, solving the serious shortage of available silicon resources, and reducing solid waste from the source.
3. In the present disclosure, there is no need of additional acid leaching solution; the sulfur dioxide in flue gas is dissolved in the pulp to promote the leaching of metal elements in the pulp and the ore waste residue, and to produce sulfuric acid, realizing “waste control by waste”.

### DETAILED DESCRIPTION

The present disclosure is further described below by combining embodiments and is not limited in any way. Any transformation or replacement based on the teachings of the present disclosure falls within the protection scope of the present disclosure.

The present disclosure includes the following steps:
S1, treatment of ore waste residue: crushing, grinding and sieving the ore waste residue to obtain an ore powder;
S2, activation and domestication of silicate bacteria: conducting activation on the silicate bacteria in an activation medium, and conducting domestication on activated silicate bacteria in a domestication medium;
S3, preparation of pulp: mixing the ore powder obtained in step S1, activated and domesticated silicate bacteria obtained in step S2, nutrients and distilled water to obtain the pulp, conducting culture until the pulp precipitates dissolved silicon, and subjecting the pulp to solid-liquid separation to remove silicon in ore;
S4, removal of sulfur dioxide: subjecting treated pulp obtained in step S3 and flue gas containing sulfur dioxide to a contact reaction, to remove the sulfur dioxide in the flue gas; and
S5, resource utilization of a desulfurization product: subjecting a reaction product obtained in step S4 to solid-liquid separation, impurity removal, concentration and crystallization, and drying sequentially, to recycle valuable metals.

In the present disclosure, in step S1, the ore waste residue is one or more selected from the group consisting of manganese oxide ore, manganese carbonate ore, pyrite, red mud, phosphorite, magnesium ore, lead-zinc ore, copper ore, nickel ore, vanadium titano-magnetite, copper slag, electrolytic manganese slag, magnesium slag, and halobolite.

In the present disclosure, in step S1, the ore powder has a particle size of less than or equal to 0.18 mm.

In the present disclosure, in step S2, the silicate bacteria are Bacillus mucilaginosus and/or Bacillus circulans.

In the present disclosure, in step S2, the activation medium includes the following raw materials: 1,000 mL of distilled water, 3 g to 6 g of sucrose, 2 g to 5 g of Na₂HPO₄, 0.1 g of CaCO₃, 0.005 g of FeCl₃, 0.5 g to 1 g of MgSO₄·7H₂O, and 1.0 g of a bauxite powder; the activation is conducted at 15° C. to 45° C., 150 r/min to 400 r/min and a pH value of 5 to 9; the bauxite is added to the medium as a silicate mineral, and is decomposed and utilized by the silicate bacteria, promoting the growth of silicate bacteria.

In the present disclosure, in step S2, the domestication medium includes the following raw materials: 1,000 mL of distilled water, 3 g to 6 g of sucrose, 2 g to 5 g of Na₂HPO₄, 0.1 g of CaCO₃, 0.005 g of FeCl₃, and 0.5 g to 1 g of MgSO₄·7H₂O; the domestication is conducted at 15° C. to 45° C., 150 r/min to 400 r/min and a pH value of 5 to 9.

In the present disclosure, in step S3, the preparation of pulp specifically includes: 10 g to 100 g of the ore powder, 3 g to 6 g of sucrose, 2 g to 5 g of Na₂HPO₄, 0.1 g of CaCO₃, 0.005 g of FeCl₃, 0.5 g to 1 g of MgSO₄·7H₂O, and the activated and domesticated silicate bacteria with a viable count of 10⁸ to 10¹¹ are added to each 1 L of the distilled water; and the pulp is cultured at 15° C. to 45° C., 150 r/min to 400 r/min and a pH value of 5 to 9 for 5 d to 15 d.

In the present disclosure, in step S4, the flue gas containing sulfur dioxide is environment set smoke-derived flue gas and/or metal smelting-derived tail gas with a sulfur dioxide concentration of less than or equal to 5,000 mg/m³.

In the present disclosure, in step S4, the contact reaction is conducted in a one-stage absorption reaction device or multi-stage absorption reaction devices; the multi-stage absorption reaction devices are connected in series sequentially, and each stage of the multi-stage absorption reaction devices is equipped with an independent pulp circulation pump and an independent pulp circulation pool; the flue gas containing sulfur dioxide is introduced from a first-stage absorption reaction device and discharged from a last-stage absorption reaction device, and the pulp in the absorption reaction device is subjected to the contact reaction with the flue gas. The absorption reaction device is a flue gas purification device well known to those skilled in the art; during the desulfurization, the multi-stage absorption reaction devices realize multi-stage circulating purification of a desulfurized slurry, improving a desulfurization efficiency and saving a cost.

In the present disclosure, in step S4, the contact reaction is conducted at 20° C. to 60° C. for 4 sec to 30 sec.

The present disclosure is further described below in conjunction with Examples 1 to 3.

### Example 1

A method for wet removal of sulfur dioxide by silicate bacteria-enhanced pulp included the following steps:
S1, treatment of ore waste residue: manganese oxide ore, manganese carbonate ore, pyrite, red mud, phosphorite, magnesium ore, lead-zinc ore, copper ore, nickel ore, vanadium titano-magnetite, copper slag, electrolytic manganese slag, magnesium slag, and halobolite were crushed, ground, and sieved by an 80-mesh sieve according to a mass ratio of 1:1:1:1:1:1:1:1:1:1:1:1:1:1 separately, and mixed well to obtain an ore powder.
S2, activation and domestication of silicate bacteria: activation was conducted on Bacillus mucilaginosus in an activation medium, and domestication was conducted on activated Bacillus mucilaginosus in a domestication medium; where the activation medium included the following raw materials: 1,000 mL of distilled water, 4.5 g of sucrose, 3.5 g of Na₂HPO₄, 0.1 g of CaCO₃, 0.005 g of FeCl₃, 0.75 g of MgSO₄·7H₂O, and 1.0 g of a bauxite powder; the activation was conducted at 30° C., 275 r/min and a pH value of 7; and the domestication medium included the following raw materials: 1,000 mL of distilled water, 4.5 g of sucrose, 3.5 g of Na₂HPO₄, 0.1 g of CaCO₃, 0.005 g of FeCl₃, and 0.75 g of MgSO₄·7H₂O; the domestication was conducted at 30° C., 275 r/min and a pH value of 7.
S3, preparation of pulp: the ore powder obtained in step S1, activated and domesticated Bacillus mucilaginosus obtained in step S2, nutrients and distilled water were mixed to obtain the pulp, where the preparation of pulp specifically included: 55 g of the ore powder, 4.5 g of sucrose, 3.5 g of Na₂HPO₄, 0.1 g of CaCO₃, 0.005 g of FeCl₃, 0.75 g of MgSO₄·7H₂O, and the activated and domesticated Bacillus mucilaginosus were added to each 1 L of the distilled water; and the pulp was cultured at 30° C., 275 r/min and a pH value of 7 for 10 d, and the pulp was subjected to solid-liquid separation to remove silicon in ore.
S4, removal of sulfur dioxide: treated pulp obtained in step S3 and environment set smoke-derived flue gas were subjected to a contact reaction at 40° C. for 17 sec, to remove the sulfur dioxide in the flue gas.
S5, resource utilization of a desulfurization product: a reaction product obtained in step S4 was subjected to solid-liquid separation, impurity removal, concentration and crystallization, and drying sequentially.

The gas after flue gas desulfurization in this example had a sulfur dioxide concentration of 99 mg/m³, and a desulfurization efficiency of 96.7%, which complied with GB-26132-2010.

### Example 2

A method for wet removal of sulfur dioxide by silicate bacteria-enhanced pulp included the following steps:
S1, treatment of ore waste residue: manganese oxide ore, pyrite, red mud, phosphorite, magnesium ore, and copper ore were crushed, ground, and sieved by an 80-mesh sieve according to a mass ratio of 1:1:1:1:1:1 separately, and mixed well to obtain an ore powder.
S2, activation and domestication of silicate bacteria: activation was conducted on Bacillus circulans in an activation medium, and domestication was conducted on activated Bacillus circulans in a domestication medium; where the activation medium included the following raw materials: 1,000 mL of distilled water, 3 g of sucrose, 2 g of Na₂HPO₄, 0.1 g of CaCO₃, 0.005 g of FeCl₃, 0.5 g of MgSO₄·7H₂O, and 1.0 g of a bauxite powder; the activation was conducted at 15° C., 150 r/min and a pH value of 5; and the domestication medium included the following raw materials: 1,000 mL of distilled water, 3 g of sucrose, 2 g of Na₂HPO₄, 0.1 g of CaCO₃, 0.005 g of FeCl₃, and 0.5 g of MgSO₄·7H₂O; the domestication was conducted at 15° C., 150 r/min and a pH value of 5.
S3, preparation of pulp: the ore powder obtained in step S1, activated and domesticated Bacillus circulans obtained in step S2, nutrients and distilled water were mixed to obtain the pulp, where the preparation of pulp specifically included: 10 g of the ore powder, 3 g of sucrose, 2 g of Na₂HPO₄, 0.1 g of CaCO₃, 0.005 g of FeCl₃, 0.5 g of MgSO₄·7H₂O, and the activated and domesticated Bacillus circulans were added to each 1 L of the distilled water; and the pulp was cultured at 15° C., 150 r/min and a pH value of 5 for 5 d, and the pulp was subjected to solid-liquid separation to remove silicon in ore.
S4, removal of sulfur dioxide: treated pulp obtained in step S3 and metal smelting-derived tail gas were subjected to a contact reaction at 20° C. for 4 sec in a one-stage absorption reaction device, to remove the sulfur dioxide in the flue gas.
S5, resource utilization of a desulfurization product: subjecting a reaction product obtained in step S4 to solid-liquid separation, impurity removal, concentration and crystallization, and drying sequentially.

### Example 3

A method for wet removal of sulfur dioxide by silicate bacteria-enhanced pulp included the following steps:
S1, treatment of ore waste residue: phosphorite was crushed, ground, and sieved by an 80-mesh sieve, and mixed well to obtain an ore powder.
S2, activation and domestication of silicate bacteria: Bacillus mucilaginosus and Bacillus circulans were used as silicate bacteria; activation was conducted on the silicate bacteria in an activation medium, and domestication was conducted on activated silicate bacteria in a domestication medium; where the activation medium included the following raw materials: 1,000 mL of distilled water, 6 g of sucrose, 5 g of Na₂HPO₄, 0.1 g of CaCO₃, 0.005 g of FeCl₃, 1 g of MgSO₄·7H₂O, and 1.0 g of a bauxite powder; the activation was conducted at 45° C., 400 r/min and a pH value of 9; and the domestication medium included the following raw materials: 1,000 mL of distilled water, 6 g of sucrose, 5 g of Na₂HPO₄, 0.1 g of CaCO₃, 0.005 g of FeCl₃, and 1 g of MgSO₄·7H₂O; the domestication was conducted at 45° C., 400 r/min and a pH value of 9.
S3, preparation of pulp: the ore powder obtained in step S1, activated and domesticated silicate bacteria obtained in step S2, nutrients and distilled water were mixed to obtain the pulp, where the preparation of pulp specifically included: 100 g of the ore powder, 6 g of sucrose, 5 g of Na₂HPO₄, 0.1 g of CaCO₃, 0.005 g of FeCl₃, 1 g of MgSO₄·7H₂O, and the activated and domesticated silicate bacteria were added to each 1 L of the distilled water; and the pulp was cultured at 45° C., 400 r/min and a pH value of 9 for 15 d, and the pulp was subjected to solid-liquid separation to remove silicon in ore.
S4, removal of sulfur dioxide: treated pulp obtained in step S3 and mixed flue gas of environment set smoke-derived flue gas and metal smelting-derived tail gas were subjected to a contact reaction at 60° C. for 30 sec in multi-stage absorption reaction devices, to remove the sulfur dioxide in the flue gas.
S5, resource utilization of a desulfurization product: subjecting a reaction product obtained in step S4 to solid-liquid separation, impurity removal, concentration, and crystallization, and drying sequentially.

What is claimed is:

1. A method for wet removal of sulfur dioxide by silicate bacteria-enhanced pulp, comprising the following steps:
S1, treatment of ore waste residue: crushing, grinding, and sieving the ore waste residue to obtain an ore powder;
S2, activation and domestication of silicate bacteria: conducting activation on the silicate bacteria in an activation medium, and conducting domestication on activated silicate bacteria in a domestication medium;
S3, preparation of pulp: mixing the ore powder obtained in step S1, activated and domesticated silicate bacteria obtained in step S2, nutrients and distilled water to obtain the pulp, conducting culture until the pulp precipitates dissolved silicon, and subjecting the pulp to solid-liquid separation to remove silicon in ore;
S4, removal of sulfur dioxide: subjecting treated pulp obtained in step S3 and flue gas containing sulfur dioxide to a contact reaction, to remove the sulfur dioxide in the flue gas; and
S5, resource utilization of a desulfurization product: subjecting a reaction product obtained in step S4 to solid-liquid separation, impurity removal, concentration, and crystallization, and drying sequentially.

2. The method for wet removal of sulfur dioxide by silicate bacteria-enhanced pulp according to claim 1, wherein in step S1, the ore waste residue is one or more selected from the group consisting of manganese oxide ore, manganese carbonate ore, pyrite, red mud, phosphorite, magnesium ore, lead-zinc ore, copper ore, nickel ore, vanadium titano-magnetite, copper slag, electrolytic manganese slag, magnesium slag, and halobolite.

3. The method for wet removal of sulfur dioxide by silicate bacteria-enhanced pulp according to claim 1, wherein in step S1, the ore powder has a particle size of less than or equal to 0.18 mm.

4. The method for wet removal of sulfur dioxide by silicate bacteria-enhanced pulp according to claim 1, wherein in step S2, the silicate bacteria are Bacillus mucilaginosus and/or Bacillus circulans.

5. The method for wet removal of sulfur dioxide by silicate bacteria-enhanced pulp according to claim 1, wherein in step S2, the activation medium comprises the following raw materials: 1,000 mL of distilled water, 3 g to 6 g of sucrose, 2 g to 5 g of Na₂HPO₄, 0.1 g of CaCO₃, 0.005 g of FeCl₃, 0.5 g to 1 g of MgSO₄·7H₂O, and 1.0 g of a bauxite powder; the activation is conducted at 15° C. to 45° C., 150 r/min to 400 r/min and a pH value of 5 to 9.

6. The method for wet removal of sulfur dioxide by silicate bacteria-enhanced pulp according to claim 1, wherein in step S2, the domestication medium comprises the following raw materials: 1,000 mL of distilled water, 3 g to 6 g of sucrose, 2 g to 5 g of Na₂HPO₄, 0.1 g of CaCO₃, 0.005 g of FeCl₃, and 0.5 g to 1 g of MgSO₄·7H₂O; the domestication is conducted at 15° C. to 45° C., 150 r/min to 400 r/min and a pH value of 5 to 9.

7. The method for wet removal of sulfur dioxide by silicate bacteria-enhanced pulp according to claim 1, wherein in step S3, the preparation of pulp specifically comprises: 10 g to 100 g of the ore powder, 3 g to 6 g of sucrose, 2 g to 5 g of Na₂HPO₄, 0.1 g of CaCO₃, 0.005 g of FeCl₃, 0.5 g to 1 g of MgSO₄·7H₂O, and the activated and domesticated silicate bacteria with a viable count of 10⁸ to 10¹¹ are added to each 1 L of the distilled water; and the pulp is cultured at 15° C. to 45° C., 150 r/min to 400 r/min and a pH value of 5 to 9 for 5 d to 15 d.

8. The method for wet removal of sulfur dioxide by silicate bacteria-enhanced pulp according to claim 1, wherein in step S4, the flue gas containing sulfur dioxide is environment set smoke-derived flue gas and/or metal smelting-derived tail gas with a sulfur dioxide concentration of less than or equal to 5,000 mg/m³.

9. The method for wet removal of sulfur dioxide by silicate bacteria-enhanced pulp according to claim 1, wherein in step S4, the contact reaction is conducted in a one-stage absorption reaction device or multi-stage absorption reaction devices; the multi-stage absorption reaction devices are connected in series sequentially, and each stage of the multi-stage absorption reaction devices is equipped with an independent pulp circulation pump and an independent pulp circulation pool; the flue gas containing sulfur dioxide is introduced from a first-stage absorption reaction device and discharged from a last-stage absorption reaction device, and the pulp in the absorption reaction device is subjected to the contact reaction with the flue gas.

10. The method for wet removal of sulfur dioxide by silicate bacteria-enhanced pulp according to claim 1, wherein in step S4, the contact reaction is conducted at 20° C. to 60° C. for 4 sec to 30 sec.
